(19) United States
(12) Patent Application Publication
(10) Pub. No.: US 2004/0140588 A1
(43) Pub. Date: Jul. 22, 2004

(54) Golf ball manufacturing method

(76) Inventor: Seiichiro Endo, Kobe-shi (JP)

Correspondence Address: BIRCH STEWART KOLASCH & BIRCH, PO BOX 747, FALLS CHURCH, VA, 22040-0747, US

(21) Appl. No.: 10/436,982

(22) Filed: May 14, 2003

(30) Foreign Application Priority Data
May 24, 2002 (JP) 2002-150510

(51) Int. Cl. B29C 45/14

(52) U.S. Cl. 264/279; 264/279.1

(57) ABSTRACT

A screw (11) of an injection molding machine (6) is moved backward toward the right side and is rotated at the same time. Consequently, a pellet (18) in a supply section (15) is molten and is caused to enter a cylinder (10) at the same time. A shutter (16) is closed. By the operation of a vacuum pump (7), the supply section (15) is sucked. Consequently, the vicinity of the supply section (15) in the cylinder (10) is also sucked. A gas generated by melting the pellet (18) is led to the vacuum pump (7) through the supply section (15) and a pipe (19), and is discharged from the vacuum pump (7) to the outside. A molten resin is stored in a portion of the cylinder (10) which is provided in front of the screw (11). The screw (11) is moved forward and the molten resin is injected from a concave portion (9) toward a mold (8) so that a cover is formed. Since a small amount of the gas flows into the mold (8), the defects of a golf ball can be reduced.

### BACKGROUND OF THE INVENTION

1. Field of the Invention

The present invention relates to a method of manufacturing a golf ball. In detail, the present invention relates to an improvement in a method of injection molding a cover.

2. Description of the Related Art

A two-pieces golf ball comprises a core and a cover. The cover is formed of a thermoplastic resin composition. The cover is generally formed by an injection molding method. In the injection molding method, first of all, a core (that is, a sphere) is put in a mold comprising a spherical cavity. The mold comprises a holding pin which can be moved forward and backward with respect to the cavity, and a vent pin for causing the cavity to communicate with the outside air. The core is held on the center of the cavity by the holding pin moved forward. Next, a resin composition is supplied to a cylinder and is molten and is then injected toward the cavity. The molten resin is filled in a gap between a cavity surface and the core. The molten resin covers the core and is then coagulated to form the cover.

Also in a three-pieces golf ball comprising a core, an inner cover (which is also referred to as a mid layer) and an outer cover, the inner cover and the outer cover are often formed by the injection molding method. In case of the formation of the inner cover of the three-pieces golf ball, similarly, a core (that is, a sphere) is put in a mold comprising a spherical cavity and a molten resin is injected around the core. In case of the formation of the outer cover of the three-pieces golf ball, a sphere having a core and an inner cover is put in a mold comprising a spherical cavity and a molten resin is injected around the sphere.

In a stage in which the sphere is held by the holding pin, air is present in a gap formed between the cavity surface and the sphere. When the molten resin flows into the cavity, the air in the cavity is discharged to the outside. The discharge is carried out through the clearances of the holding pin and the vent pin.

The resin composition to be supplied to the cylinder contains some water. When the resin composition is molten, the water is vaporized to be a gas. The resin composition is molten so that gases are also generated due to the vaporization or reaction of chemicals in the resin composition. These gases also flow into the cavity and are discharged from the clearances of the holding pin and the vent pin.

At an early stage of the injection, the gas is discharged from both the clearance of the holding pin and that of the vent pin. When the molten resin flows into the cavity to some extent, the clearance of the holding pin is blocked by the molten resin. Then, the gas is discharged from only the clearance of the vent pin. In the case in which the clearance of the vent pin is too small, the gas is discharged insufficiently. In the case in which the clearance is too large, the molten resin flows into the clearance. In consideration of the prevention of these drawbacks, the clearance of the vent pin is set to be 50 μm.

Japanese Laid-Open Patent Publication No. 2000-37480 has disclosed a technique for forming a pin by a porous material to enhance a gas discharging property. By repetitively using the pin, holes are clogged. The pin is expensive. In addition, the pin is fragile and is apt to be broken. The pin formed by the porous material is not practical.

The insufficient discharge of the gas causes defects, for example, the invasion of the air into the cover, a weld mark (a linear mark generated in the bonding portions of resins), bare (a space generated by a residual gas) and scorching (discoloration caused over the cover). In particular, in the case in which the flow velocity of the molten resin is high, the gas is apt to be discharged insufficiently. In recent years, a golf ball comprising a cover having a small thickness to enhance a hitting feeling has been developed and put on the market. In the formation of the cover of the golf ball, it is necessary to fill the molten resin at a high speed, and there is a problem in that the defective discharge of a gas is caused.

### SUMMARY OF THE INVENTION

The present invention provides a method of manufacturing a golf ball comprising the steps of:

(A) supplying a thermoplastic resin to a cylinder and carrying out heating to obtain a molten resin;

(B) injecting the molten resin around a sphere provided in a mold having a spherical cavity; and

(C) coagulating the molten resin to form a cover.

An inner part of the cylinder is sucked at the melting step.

In the manufacturing method, a gas generated by melting a resin composition is discharged to the outside by the suction in the cylinder. Accordingly, the gas flowing into the cavity can be reduced so that the gas can be prevented from remaining. Thus, defects can be prevented from being caused by the gas.

Also in the case in which a cover having a thickness of 1.7 mm or less is to be formed, a rate of defects caused by the gas can be reduced by the suction in the cylinder.

Also in the case in which a mold having a clearance between a vent pin hole and a vent pin of 50 μm or less is used, the rate of defects caused by the gas can be reduced by the suction in the cylinder. By using the mold, a spew can be prevented from being generated by the flow of the molten resin into the clearance. In the golf ball obtained by the mold, a work for removing the spew can easily be carried out.

It is preferable that the inner part of the cylinder should be sucked at the melting step through a supply section for supplying the thermoplastic resin to the cylinder. By the manufacturing method, the air entering the supply section can be prevented from flowing into the cylinder.

### BRIEF DESCRIPTION OF THE DRAWINGS

FIG. 1 is a sectional view showing a golf ball obtained by a manufacturing method according to an embodiment of the present invention, a part of which is taken away,

FIG. 2 is a sectional view showing an apparatus for manufacturing the golf ball in FIG. 1, a part of which is taken away, and

FIG. 3 is a sectional view showing a part of a mold of the manufacturing apparatus in FIG. 2.

### DESCRIPTION OF THE PREFERRED EMBODIMENTS

A preferred embodiment of the present invention will be described below in detail with reference to the drawings.

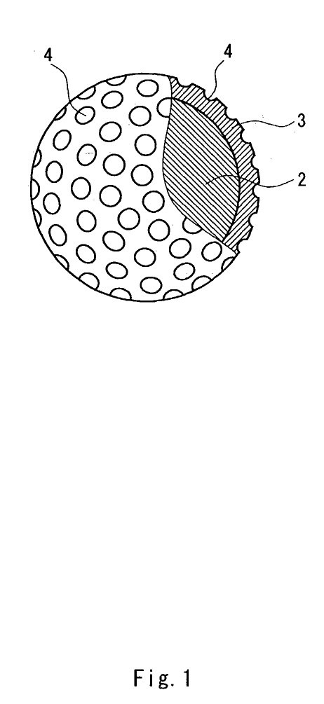

A golf ball 1 shown in FIG. 1 has a two-pieces structure and comprises a core 2 to be a sphere and a cover 3. The core 2 is formed by crosslinking a rubber composition. The cover 3 is formed of a resin composition containing a thermoplastic resin as a principal component. A large number of dimples 4 are formed on the surface of the cover 3. The golf ball 1 has a paint layer and a mark layer on the outside of the cover 3, which are not shown. The golf ball 1 usually has a diameter of 40 mm to 45 mm, particularly 42 mm to 44 mm. In consideration of a reduction in an air resistance within such a range that the standards of the United States Golf Association (USGA) are satisfied, it is preferable that the diameter should be 42.67 mm to 42.80 mm. The golf ball 1 usually has a weight of 40 g to 50 g, particularly 44 g to 47 g. In consideration of an enhancement in an inertia within such a range that the standards of the USGA are satisfied, it is preferable that the weight should be 45.00 g to 45.93 g.

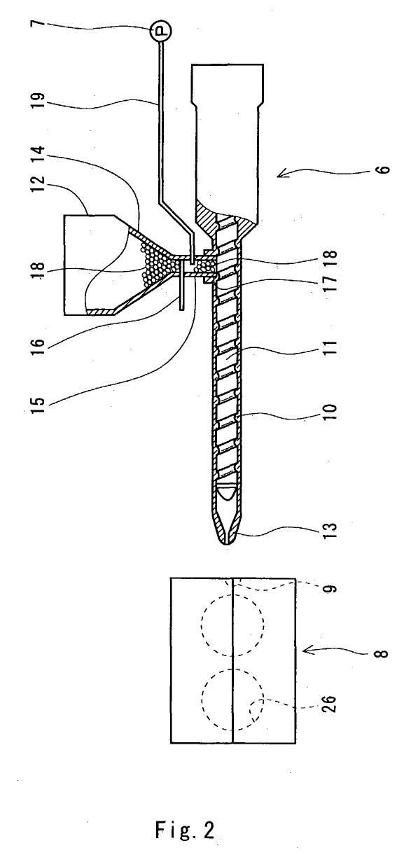

FIG. 2 is a sectional view showing an apparatus 5 for manufacturing the golf ball 1 in FIG. 1, a part of which is taken away. In FIG. 2, an injection molding machine 6, a vacuum pump 7 and a mold 8 are shown. In FIG. 2, the injection molding machine 6 is provided apart from the mold 8. The injection molding machine 6 can be moved in a transverse direction in FIG. 2. When the injection molding machine 6 is moved leftwards, the tip of the injection molding machine 6 and a concave portion 9 of the mold 8 come in contact with each other.

The injection molding machine 6 comprises a cylinder 10, a screw 11 and a hopper 12. The tip of the cylinder 10 acts as a nozzle 13. The screw 11 is stored in the cylinder 10. The hopper 12 includes a body 14, a supply section 15 and a shutter 16. The shutter 16 is constituted to be openable. In a state in which the shutter 16 is opened, the body 14 communicates with the supply section 15. In a state in which the shutter 16 is closed, the body 14 is blocked from the supply section 15. The supply section 15 is inserted in an opening 17 formed on the upper surface of the cylinder 10. A pellet 18 (a granular thermoplastic resin composition) is stored in the hopper 12.

The vacuum pump 7 is connected to the hopper 12 through a pipe 19. The tip of the pipe 19 reaches the supply section 15 of the hopper 12.

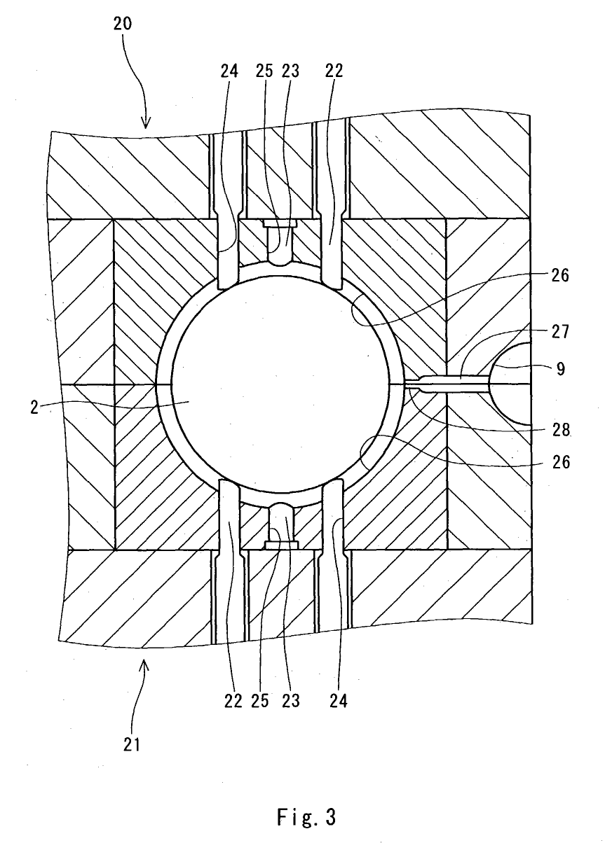

FIG. 3 is a sectional view showing a part of the mold 8 of the manufacturing apparatus 5 in FIG. 2. The mold 8 comprises an upper mold 20, a lower mold 21, a plurality of holding pins 22 and two vent pins 23. The holding pins 22 are positioned at an equal distance from pole in the upper mold 20 and the lower mold 21, respectively. Each of the upper mold 20 and the lower mold 21 is provided with three to eight holding pins 22, particularly three to six holding pins 22, respectively. FIG. 3 shows two holding pins 22 in each of the upper mold 20 and the lower mold 21. The holding pin 22 penetrates through a holding pin hole 24. The vent pin 23 is positioned on the pole of the upper mold 20 and that of the lower mold 21. The vent pin 23 is inserted in a vent pin hole 25. The tips of the holding pin 22 and the vent pin 23 are protruded. The dimple 4 is formed on the golf ball 1 by the protruded portions. When the tips of the pins 22 and 23 are to abut on a land (a portion other than the dimple 4 which is provided on the surface of the golf ball 1), the tips of the pins 22 and 23 may be flat.

Each of the upper mold 20 and the lower mold 21 has a hemispherical cavity surface 26. When the mold 8 is clamped, a spherical cavity is formed by the cavity surface 26 of the upper mold 20 and that of the lower mold 21 as shown in FIG. 3. A plurality of projections are formed on the cavity surface 26, which is not shown. During the formation of the cover 3, the dimple 4 having a shape obtained by inverting the shape of the projection is provided by the projection. When the mold 8 is clamped, a runner 27, a gate 28 and the concave portion 9 are formed. The runner 27 and the gate 28 have circular sectional shapes. The concave portion 9 has a hemispherical shape.

The holding pin 22 is constituted to be movable forward and backward. FIG. 3 shows a state in which the holding pin 22 is moved forward, that is, a state in which the tip of the holding pin 22 approaches the center of the cavity. The core 2 is held on the center of the cavity by means of the holding pin 22.

In the case in which the golf ball 1 is to be formed by the manufacturing apparatus 5, the screw 11 of the injection molding machine 6 is first moved backward toward the right side and is rotated at the same time. By the rotation, the pellet 18 in the supply section 15 is caused to enter the cylinder 10. The cylinder 10 is heated by heating means which is not shown. Therefore, the pellet 18 is gradually molten with the entrance. At this time, the shutter 16 is closed. By the operation of the vacuum pump 7, the supply section 15 is sucked so that the vicinity of the supply section 15 in the cylinder 10 is also sucked. A gas generated by melting the pellet 18 is led to the vacuum pump 7 through the supply section 15 and the pipe 19 and is discharged from the vacuum pump 7 to the outside. A molten resin is stored in a portion of the cylinder 10 which is provided in front of the screw 11.

On the other hand, the core 2 is put in the cavity of the lower mold 21 and mold clamping is carried out. Almost simultaneously with the mold clamping, the holding pin 22 is moved forward so that the core 2 is held on the center of the cavity as shown in FIG. 3.

Next, the injection molding machine 6 is moved forward toward the left side and the nozzle 13 is pushed to come in contact with the concave portion 9. Next, the screw 11 is moved forward so that the molten resin is injected from the concave portion 9 toward the mold 8. The molten resin passes through the runner 27 and the gate 28 and is then injected into the cavity. With the injection, the air in the cavity is gradually discharged to the outside from a clearance formed between the holding pin 22 and the holding pin hole 24 and a clearance formed between the vent pin 23 and the vent pin hole 25. Immediately before the molten resin is completely injected, the holding pin 22 is moved backward. By the backward movement, the tip of the holding pin 22 is almost coincident with the cavity surface 26. The holding pin 22 is moved away from the core 2 and the molten resin is present between the core 2 and the cavity surface 26. Therefore, the core 2 is rarely moved. After the holding pin 22 is moved backward, similarly, a small amount of the molten resin is injected into the cavity so that the whole peripheral surface of the core 2 is covered with the molten resin. The molten resin is cooled and coagulated so that the cover 3 is formed.

In the manufacturing method, the gas generated by melting the pellet 18 is discharged through the vacuum pump 7. Consequently, the gas can be-prevented from flowing into the cavity. In other words, a small amount of the gas is to be discharged from a clearance formed between the vent pin 23 and the vent pin hole 25. In the manufacturing method, the gas can be prevented from remaining in the cavity so that defects caused by the gas can be reduced. In addition, in the manufacturing method, water contained in the molten-resin is removed by the vacuum pump 7. Consequently, the water content of the cover 3 can be controlled. The cover 3 having a small water content is excellent in a durability.

By the suction of the vacuum pump 7, a pressure is reduced in the supply section 15 and the cylinder 10. By the reduction in the pressure, the vaporization of water and chemicals from the molten resin is promoted. From this viewpoint, an internal pressure of the supply section 15 (an internal pressure of the cylinder 10 in the vicinity of the supply section 15) is preferably 0.5 atm (0.051 MPa) or less, more preferably 0.4 atm (0.041 MPa) or less and particularly preferably 0.3 atm (0.030 MPa) or less.

When the amount of the pellet 18 in the supply section 15 is reduced, the shutter 16 is opened. Consequently, the pellet 18 stored in the hopper 12 is dropped to the supply section 15. After a predetermined amount of the pellet 18 is dropped, the shutter 16 is closed. The internal pressure of the supply section 15 is raised while the shutter 16 is opened. Since a time required for opening the shutter 16 is short (for example, several seconds to several tens seconds), the discharge of the gas is less influenced adversely.

The manufacturing apparatus 5 is suitable for the formation of the cover 3 having a thickness of 1.7 mm or less, that is, the thin cover 3. In the formation of the thin cover 3, a gap formed between the core 2 and the cavity surface 26 is small. For this reason, the molten resin is to be injected at a high speed. In the injection of the molten resin at a high speed, the gas is apt to remain. In the manufacturing method according to the present invention, however, the gas is previously discharged by means of the vacuum pump 7. Also in case of the formation of the thin cover 3, therefore, defects are caused with difficulty. The manufacturing method according to the present invention is particularly suitable for the formation of the cover 3 having a thickness of 1.5 mm or less. It is hard to form the excessively thin cover 3 by the injection molding method. The ordinary cover 3 has a thickness of 0.5 mm or more.

In the manufacturing method, a small amount of the gas flows into the cavity. Also in the case in which the clearance of the vent pin 23 is small, therefore, defects are caused with difficulty. By using a mold having a small clearance, the size of a spew caused by the flow of the molten resin into the clearance can be reduced. A small spew does not deteriorate the appearance of the golf ball 1 even if it is not removed at a subsequent step. Also in the case in which the spew is to be removed, a removing work can easily be carried out because of a small size. The manufacturing method also contributes to an enhancement in the appearance of the golf ball for an enhancement in productivity thereof. From this viewpoint, the clearance of the vent pin 23 is preferably 50 μm or less, more preferably 20 μm or less and particularly preferably 10 μm or less. If the clearance is too small, the air present originally in the gap formed between the core 2 and the cavity surface 26 is discharged insufficiently. For this reason, the clearance is preferably 5 μm or more.

A clearance C of the vent pin 23 is calculated by the following equation, wherein the inside diameter of the vent pin hole 25 is represented by D and the outside diameter of the vent pin 23 is represented by d.

C=(D−d)/2

In FIG. 2, the pipe 19 is connected to the supply section 15. In other words, the inner part of the cylinder 10 is sucked through the supply section 15. By the suction, the air present in the supply section 15 is removed in addition to the gas of the cylinder 10 so that the air can be prevented from flowing into the cylinder 10. An attachment hole may be formed on the cylinder 10 and the tip of the pipe 19 may be attached into the attachment hole. In this case, the cylinder 10 is directly sucked without using the supply section 15.

The cover 3 to which the manufacturing method is applied contains a thermoplastic resin as a principal component. Examples of a preferable thermoplastic resin include an ionomer resin and thermoplastic elastomer. Specific examples of the thermoplastic elastomer include thermoplastic styrene elastomer, thermoplastic polyurethane elastomer, thermoplastic polyamide elastomer and thermoplastic polyester elastomer. Thermoplastic styrene elastomer (thermoplastic elastomer containing a styrene block) is particularly suitable for the thermoplastic elastomer. The thermoplastic styrene elastomer includes a styrene-butadiene-styrene block copolymer (SBS), a styrene-isoprene-styrene block copolymer (SIS), a styrene-isoprene-butadiene-styrene block copolymer (SIBS), hydrogenated SBS, hydrogenated SIS and hydrogenated SIBS. Examples of the hydrogenated SBS include a styrene-ethylene-butylene-styrene block copolymer (SEBS). Examples of the hydrogenated SIS include a styrene-ethylene-propylene-styrene block copolymer (SEPS) Examples of the hydrogenated SIBS include a styrene-ethylene-ethylene-propylene-styrene block copolymer (SEEPS).

### EXAMPLES

### Example 1

100 parts by weight of polybutadiene (trade name “BROL” manufactured by JSR Co., Ltd.), 22.5 parts by weight of zinc acrylate, 8 parts by weight of zinc oxide, 0.8 part by weight of dicumyl peroxide and a proper amount of barium sulfate were kneaded by means of a kneader to obtain a rubber composition. The rubber composition was put in a mold and was thus heated to cause a rubber to carry out a crosslinking reaction. Thus, a spherical core having a diameter of 40.5 mm was obtained. A crosslinking temperature was set to be 160° C. and a crosslinking time was set to be 25 minutes. On the other hand, 50 parts by weight of an ionomer resin (trade name “Surlyn 8945” manufactured by Dupont Co., Ltd.), 50 parts by weight of another ionomer resin (trade name “Surlyn 9945” manufactured by Dupont Co., Ltd.) and 2 parts by weight of titanium dioxide were kneaded by means of a twin extruder so that a pellet-like resin composition was obtained. Next, the manufacturing apparatus shown in FIG. 2 was prepared to form a cover having a thickness of 1.1 mm around a core by using the pellet. In this case, a cylinder was sucked by means of a vacuum pump. A vent pin clearance of the mold of the manufacturing apparatus was set to be 20 μm.

### Comparative Example 1

A cover was formed in the same manner as in the example 1 except that the suction was not carried out.

### Example 2 and Comparative Example 2

In an example 2, a cover was formed in the same manner as in the example 1 except that a mold having a vent pin clearance of 60 μm was used. In a comparative example 2, a cover was formed in the same manner as in the example 1 except that the mold having a vent pin clearance of 60 μm was used.

### Example 3 and Comparative Example 3

In an example 3, a cover having a thickness of 1.6 mm was formed in the same manner as in the example 1 except that a core having a diameter of 39.5 mm was used and a mold having a vent pin clearance of 5 μm was used. In a comparative example 3, the cover having a thickness of 1.6 mm was formed in the same manner as in the example 1 except that the core having a diameter of 39.5 mm was used and the mold having a vent pin clearance of 5 μm was used.

### Example 4 and Comparative Example 4

In an example 4, a cover having a thickness of 1.6 mm was formed in the same manner as in the example 1 except that a core having a diameter of 39.5 mm was used, a mold having a vent pin clearance of 100 m was used and a pellet containing 100 parts by weight of polyurethane thermoplastic elastomer (trade name “Elastolan ET880” manufactured by BASF Polyurethane Elastomers Co., Ltd.) and 2 parts by weight of titanium dioxide was used. In a comparative example 4, the cover having a thickness of 1.6 mm was formed in the same manner as in the example 1 except that the core having a diameter of 39.5 mm was used, the mold having a vent pin clearance of 10 μm was used and the pellet containing 100 parts by weight of thermoplastic polyurethane elastomer (the trade name “Elastolan ET880” described above) and 2 parts by weight of titanium dioxide was used.

### Example 5 and Comparative Example 5

In an example 5, a cover having a thickness of 2.2 mm was formed in the same manner as in the example 1 except that a core having a diameter of 38.3 mm was used and a mold having a vent pin clearance of 10 μm was used. In a comparative example 5, the cover having a thickness of 2.2 mm was formed in the same manner as in the example 1 except that the core having a diameter of 38.3 mm was used and the mold having a vent pin clearance of 10 m was used.

[Observation of Spew]

A spew formed in a position corresponding to the vent pin clearance of the cover thus obtained was observed visually and a size thereof was evaluated. A result is shown in the following Table 1.

[Observation of Defect]

The surface of the cover thus obtained was observed visually and the number of golf balls having residual air and the number of golf balls generating a weld mark were counted. A result is shown in the following Table 1.

[Evaluation of Durability]

A driver having a metal head was attached to a swing robot (manufactured by True Temper Co.). A golf ball was hit with the driver and was caused to collide against a collision plate. The hitting and the collision were repeated and the number of the hitting operations carried out until the golf ball was broken was counted to obtain an endurance index. The following Table 1 shows the minimum and maximum values of the endurance indices obtained by giving this test to 36 golf balls. The endurance index of the golf ball which was not broken with 150-time hitting is represented as “150 up”.

TABLE 1
Result of Evaluation

| | | | Com. | | Com. | | Com. | | Com. | | Com. |
|---|---|---|---|---|---|---|---|---|---|---|---|
| | | Exam. 1 | Exam. 1 | Exam. 2 | Exam. 2 | Exam. 3 | Exam. 3 | Exam. 4 | Exam. 4 | Exam. 5 | Exam. 5 |
| Core diameter (mm) | | 40.5 | 40.5 | 40.5 | 40.5 | 39.5 | 39.5 | 39.5 | 39.5 | 38.3 | 38.3 |
| Cover thickness (mm) | | 1.1 | 1.1 | 1.1 | 1.1 | 1.6 | 1.6 | 1.6 | 1.6 | 2.2 | 2.2 |
| Base material of cover | | I | I | I | I | I | I | U | U | I | I |
| Vent pin clearance (μm) | | 20 | 20 | 60 | 60 | 5 | 5 | 10 | 10 | 10 | 10 |
| Suction | | Yes | No | Yes | No | Yes | No | Yes | No | Yes | No |
| Spew size | | Small | Small | Large | Large | Small | Small | Small | Small | Small | Small |
| Fabrications | | 10720 | 10200 | 10800 | 10120 | 11030 | 11100 | 10740 | 10360 | 10600 | 11000 |
| Residual air | | 0 | 826 | 0 | 402 | 0 | 318 | 0 | 321 | 0 | 27 |
| Weld mark | | 0 | 215 | 0 | 128 | 0 | 162 | 0 | 186 | 0 | 4 |
| Endurance | Minimum | 136 | 38 | 134 | 72 | 150 up | 78 | 150 up | 42 | 150 up | 61 |
| | Maximum | 150 up | 150 up | 150 up | 150 up | 150 up | 150 up | 150 up | 150 up | 150 up | 150 up |

I: Ionomer resin
U: Thermoplastic polyurethane elastomer

In the Table 1, a rate of defects in the manufacturing method according to each of the examples is lower than that in the manufacturing method according to each of the comparative examples. In addition, the golf ball obtained by the manufacturing method according to each of the examples is more excellent in a durability than the golf ball obtained by the manufacturing method according to each of the comparative examples. Based on the result of the evaluation, the advantage of the present invention is apparent.

While the case in which the cover of a two-pieces golf ball is formed has been taken as an example in the above description, the manufacturing method according to the present invention can also be applied to the formation of the inner cover and the outer cover of a three-pieces golf ball. Furthermore, the manufacturing method according to the present invention can also be applied to the formation of each cover of the golf ball comprising three cover layers or more.

The above description is only illustrative and can be variously changed without departing from the scope of the present invention.

What is claimed is:

1. A method of manufacturing a golf ball comprising the steps of:
supplying a thermoplastic resin to a cylinder and carrying out heating to obtain a molten resin;
injecting the molten resin around a sphere provided in a mold having a spherical cavity; and
coagulating the molten resin to form a cover,
wherein an inner part of the cylinder is sucked at the melting step.

2. The method of manufacturing a golf ball according to claim 1, wherein the cover obtained at the coagulating step has a thickness of 1.7 mm or less.

3. The method of manufacturing a golf ball according to claim 1, wherein the mold to be used at the injecting step includes a vent pin hole and a vent pin inserted in the vent pin hole, and a clearance between the vent pin hole and the vent pin is 50 μm or less.

4. The method of manufacturing a golf ball according to claim 2, wherein the mold to be used at the injecting step includes a vent pin hole and a vent pin inserted in the vent pin hole, and a clearance between the vent pin hole and the vent pin is 50 μm or less.

5. The method of manufacturing a golf ball according to claim 1, wherein the inner part of the cylinder is sucked at the melting step through a supply section for supplying the thermoplastic resin to the cylinder.
